(19) United States
(12) Patent Application Publication
(10) Pub. No.: US 2025/0262567 A1
(43) Pub. Date: Aug. 21, 2025

(54) METHODS FOR MITIGATING PRODUCED WATER COOLER FOULING

(71) Applicant: ChampionX LLC, Sugar Land, TX (US)

(72) Inventors: Ming-Zhao Jin, Sherwood Park (CA); Dingzheng Yang, Edmonton (CA); Marvin Patrick Power, Calgary (CA); Song Gao, Calgary (CA); Brandyn Michael Jones, Calgary (CA)

(21) Appl. No.: 19/054,467

(22) Filed: Feb. 14, 2025

Related U.S. Application Data
(60) Provisional application No. 63/553,696, filed on Feb. 15, 2024.

(51) Int. Cl. B01D 17/04; C02F 1/68; C02F 101/32; C02F 103/10

(52) U.S. Cl. CPC B01D 17/047; C02F 1/682; C02F 2101/32; C02F 2103/10

(57) ABSTRACT

Methods for mitigating produced water cooler fouling in steam assisted gravity drainage (SAGD) systems are disclosed. In addition, methods for reducing fouling in SAGD systems with a produced water cooler by injecting a production fluid with a reverse emulsion with a demulsifier prior to phase separation of the production fluid, where the separation of water from the reverse emulsion is at a temperature above about 100° C. to form a separated water phase for subsequent steam generation, are disclosed.

### CROSS REFERENCE TO RELATED APPLICATION

This application claims priority under 35 U.S.C. § 119 to Provisional Application U.S. Ser. No. 63/553,696, filed on Feb. 15, 2024, which is herein incorporated by reference in its entirety including without limitation, the specification, claims, and abstract, as well as any figures, tables, or examples thereof.

### TECHNICAL FIELD

The disclosure relates generally to methods for mitigating produced water cooler fouling in steam assisted gravity drainage (SAGD) systems. More particularly, methods for reducing fouling in SAGD systems with a produced water cooler are provided by injecting a production fluid with a reverse emulsion with a demulsifier prior to phase separation of the production fluid, where the separation of water from the reverse emulsion is at a temperature above about 100° C. to form a separated water phase for subsequent steam generation.

### BACKGROUND

The background description provided herein gives context for the present disclosure.

Fouling of produced water coolers is a persistent problem in oil sands steam-assisted gravity drainage (SAGD) and thermal production facilities, causing significant financial burden on oil producers as millions of dollars are spent annually to address this issue. Conventional methods to address fouling of produced water coolers includes injecting antifoulant into a produced water phase after it is separated from an organic phase, prior to heat exchange and cooling. However, fouling in the produced water coolers continues to be a problem.

In a SAGD process, emulsion breakers and reverse emulsion breakers are injected into the reverse emulsion from the well prior to a water-oil separation vessel. The emulsion breaker, tasked with separating the internal phase, is conventionally thought to play no significant role in the cooling process of the produced water.

It is an object of this disclosure to provide a method wherein one or more demulsifiers are injected prior to water-oil separation, with or without conventional emulsion breakers, that beneficially reduce fouling in the downstream produced water-cooling systems. Among other outcomes, reducing fouling in the downstream water-cooling systems increases the throughput in said cooling systems, increases the number of days between downtime cleaning events for said cooling systems, and allows for the reduction of the temperature of the cooled produced water, for example below 100° C.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

Described herein are methods for reducing fouling in a water cooler in a Steam Assisted Gravity Drainage system comprising injecting a production fluid with at least one demulsifier that is a resin, sorbitol, triol, crosslinked polyglycol, or combination thereof combined with an additional demulsifier for water-oil separation prior to phase separation of the production fluid, separating water from the reverse emulsion at a temperature above about 100° C. to form a produced water phase, wherein the produced water has a reduced amount of organic residue thereby reducing fouling of a produced water cooler. In an embodiment, the demulsifier is a resin selected from the group consisting of butyl resin, nonyl/butyl resin, amyl resin, nonyl resin, nonylphenyl resin, EPON resin, alkoxylated sorbitol, and sorbitol/EPON resin crosslinked. In an embodiment, the demulsifier is further combined with an additional demulsifier comprising a polyamine, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, or combinations thereof.

In an embodiment, the methods comprising injecting of the production fluid with an additional emulsion breaker. In an embodiment, the additional emulsion breaker and demulsifier are provided in a single composition or are injected separately into the production fluid.

In an embodiment, the demulsifier comprises from about 0.1 wt-% to about 20 wt-% of the composition, and the additional emulsion breaker comprises from about 20 wt-% to about 99.9 wt-% of the composition. In an embodiment, the demulsifier comprises from about 1 wt-% to about 10 wt-% of the composition, and the additional emulsion breaker comprises from about 90 wt-% to about 99 wt-% of the composition. In an embodiment, the demulsifier and if present the additional emulsion breaker are injected at a concentration of from about 5 ppm to about 100 ppm, or from about 5 ppm to about 70 ppm, or from about 10 ppm to about 30 ppm.

In an embodiment, the method further comprises injecting the production fluid with an antifouling chemistry. In another embodiment, the method does not comprise injecting the production fluid with an antifouling chemistry.

In an embodiment, the injecting is at a temperature between about 110-160° C. In an embodiment, the produced water phase is cooled to a temperature of less than about 100° C. in a produced water cooler comprising a heat exchanger. In an embodiment, the produced water phase is cooled to a temperature of about 80° C. in the produced water cooler.

In an embodiment, the methods result in increased time between produced water cooler cleaning compared to an otherwise identical method absent the injection of the demulsifier. In an embodiment, the time between produced water cooler cleaning is at least about 8 days, at least about 10 days, or at least about 15 days. In an embodiment, the method results in increased total water throughput in the produced water cooler compared to an otherwise identical method absent the injection of the demulsifier. In an embodiment, the total water throughput is increased by at least about 50%, by at least about 75%, or at least about 90%.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a schematic diagram of the portion of a SAGD process wherein the reverse emulsion from the well is injected with a reverse emulsion breaker and an emulsion breaker and the chemistry described herein prior to the separation vessel.

FIG. 2 shows a schematic diagram of a typical SAGD process.

FIG. 3 is a graph of the days before fouling required taking the produced water cooler offline for cleaning as impacted by the coagulant and demulsifier compositions.

FIG. 4 is a graph of the total water throughput (m³) before fouling levels required taking the produced water cooler offline for cleaning as impacted by the coagulant and demulsifier compositions.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been beneficially found that fouling in a water cooler in a Steam Assisted Gravity Drainage system can be substantially reduced by injecting a production fluid with at least one demulsifier that is a resin, sorbitol, triol, crosslinked polyglycol, or combination thereof combined with an additional demulsifier for water-oil separation prior to phase separation of the production fluid.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “between” is inclusive of any endpoints noted relative to a described range. When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

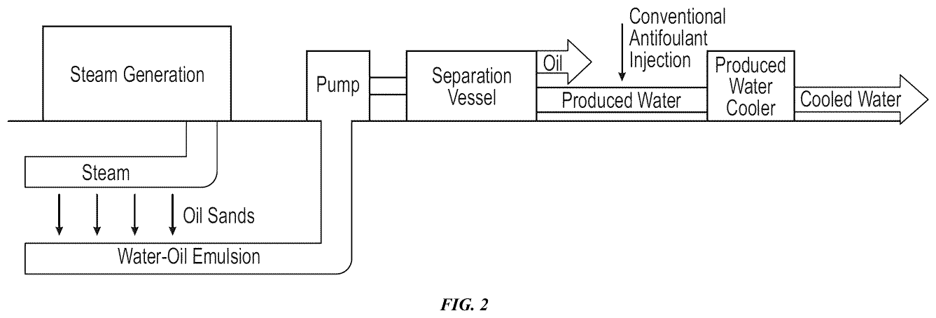

Disclosed herein are methods for mitigating fouling in produced water coolers. Disclosed herein are methods for mitigating fouling in produced water coolers in a SAGD system. A schematic for an exemplary basic SAGD system is shown in FIG. 2. In an exemplary SAGD system, oil is recovered through a pair of horizontal wells. Steam is injected into a top well, reducing the viscosity of bitumen which flows to the lower well. A production fluid is recovered. The production fluid comprises bitumen and water, can have a temperature of upwards of 200° C., and is a stable complex emulsion. The production fluid is then sent through separation vessels to separate the oil from the produced water. Once separated, the oil is sent for further processing and the produced water is sent through one or more produced water coolers. The cooled water, or a portion thereof, can then be reused for steam and/or sent for more processing. Conventional methods to mitigate heat exchanger fouling include injecting anti-foulant chemistry into produced water after phase separation, before cooling.

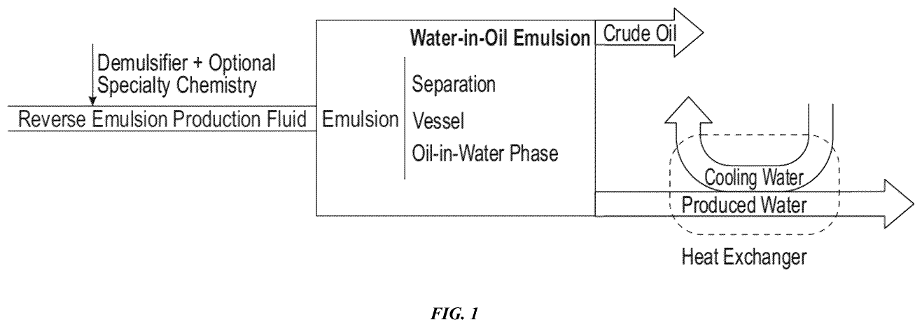

In the methods described herein, a demulsifier is injected into the production fluid prior to separation. Prior to separation includes any portion of the process after emulsion production. For example, the injection can be upstream of a separation vessel, or at an inlet to a separation vessel. A schematic of an exemplary method is shown in FIG. 1. In FIG. 1 a demulsifier, and optionally an additional specialty chemistry component, such as an emulsion breaker, is injected into the production fluid upstream of a separation vessel. In the separation vessel a crude oil phase is separated from a water phase and sent for further processing. The produced water phase, with reduced residual organics, is then cooled in the produced water cooler. FIG. 1 shows an exemplary counter-current heat exchanger.

The production fluid has a reverse emulsion, meaning the emulsion is an oil-in-water or ‘reverse’ emulsion that require a demulsifying agent, or a demulsifier as described herein. The production fluid having a reverse emulsion has water as the external phase with an internal phase that is also an emulsion (water in oil).

Unlike conventional methods where a flocculant or coagulant type oil-in-water demulsification agent (also referred to as reverse breakers) are often used to break these emulsions downstream, where the emulsion has cooled and been separated from a bulk oil phase, the present disclosure breaks the reverse emulsion prior to phase separation of the production fluid and employs a distinct selection of demulsifiers beyond the conventional flocculant or coagulant type oil-in-water demulsification agents, such as various cationic organic polymers: polyamine condensates, polyvinylamines, polyaminoacrylates, and the like, along with alkylphenols, alkylamines, alkylols, and polyol alkoxylates with or without cross linking with aldehydes, di- or multi-functional acids, epoxides, isocyanates and the like.

In an embodiment, the method for reducing fouling in a produced water cooler comprises injecting a production fluid with a reserve emulsion with a demulsifier that includes a resin, sorbitol, triol, crosslinked polyglycol, or combination thereof prior to phase separation of the production fluid, separating water from the reverse emulsion forming a produced water phase, wherein the produced water phase has a reduced amount of organic residue. In an embodiment, the phase separation occurs at a temperature above about 100° C., from about 100° C. to about 200° C., from about 110° C. to about 160° C., or at about 140° C. In an embodiment, the produced water after separation is at a temperature above about 100° C., from about 100° C. to about 200° C., from about 110° C. to about 160° C., or at about 140° C.

In an embodiment, the demulsifier can include a phenolic resin, epoxide resin, a polyol, a polyamine, dodecylbenzenesulfonic acid (DDBSA), trimethylolpropane (TMP), 2-Mercaptoethanol, alkyl pyridine, alkyl pyridine quaternary ammonium compound, hydroquinone, imidazoline, alkoxylated sorbitol, or combinations thereof. It is envisioned that at least one and preferably at least two or at least three demulsifiers are employed in the methods described herein.

In embodiments the demulsifier includes a resin selected from the group consisting of butyl resin, nonyl/butyl resin, amyl resin, nonyl resin, nonylphenyl resin, epoxy resin, and crosslinked sorbitol/epoxy resin. An exemplary type of epoxy resin is commercially available under the tradename EPON® epoxy resin. Various reaction products of resins with polymers can also be employed, including for example ethylene oxide (EO) polymers and/or propylene oxide (PO) polymers. In embodiments the demulsifier is a polyol that can include a sorbitol, triol, crosslinked polyglycol, alkoxylated sorbitol, or combinations thereof. In embodiments the demulsifier is an oxyalkylate polymer, such as a polyalkylene glycol.

In embodiments, the demulsifier comprises alkoxylated polymers with amine, sorbitol and/or resin backbone structures. In embodiments, the polymers can have an acceptor percentage of about 0.5% to about 85%, with the remaining percentage comprising EO and/or PO chains. In embodiments, the ratio of EO to PO in in the rage of 10:0.1 to 0.1:10, or from 10:1 to 1:10. In embodiments, the demulsifier polymer comprises only PO or only EO chains.

In embodiments the additional demulsifier includes a polyamine, dodecylbenzenesulfonic acid (DDBSA), trimethylolpropane (TMP), 2-Mercaptoethanol, alkyl pyridine, alkyl pyridine quaternary ammonium compound, hydroquinone, imidazoline, or combinations thereof.

In such embodiments, the first demulsifier is a resin selected from the group consisting of butyl resin, nonyl/butyl resin, amyl resin, nonyl resin, nonylphenyl resin, EPON resin, and sorbitol/EPON resin crosslinked, and/or is a sorbitol, triol, crosslinked polyglycol, alkoxylated sorbitol, or combination thereof, is combined with an additional demulsifier selected from the group consisting of a polyamine, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, and combination thereof.

In additional embodiments, the first demulsifier is a sorbitol, triol, crosslinked polyglycol, or combination thereof, and is combined with an additional demulsifier selected from the group consisting of a polyamine, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, and combination thereof.

In addition to the at least one demulsifier that is a resin, sorbitol, triol, crosslinked polyglycol, or combination thereof and an additional demulsifier, the methods preferably also include one or more additional emulsion breakers for injecting into the production fluid. Exemplary additional emulsion breakers include an amine, resin, sorbitol, triol, crosslinked polyglycols, or a combination thereof. In embodiments, the additional emulsion breaker comprises ethylenediamine, diethylenetriamine, triethylenetetramine, tetraethylenepentamine, pentaethylenehexamine, and/or polyethyleneimine. Preferred emulsion breakers include ethylenediamine and diethylenetriamine. Exemplary additional emulsion breakers may also include coagulants and flocculants acting as reverse demulsifiers.

When additional emulsion breakers are used in combination with the demulsifiers they can be provided in a single composition or injected separately into the production fluid. In embodiments where a single composition is injected, the demulsifier comprises from about 0.1 wt-% to about 20 wt-% of the composition and the additional emulsion breaker comprises from about 20 wt-% to about 99.9 wt-% of the composition, or the demulsifier comprises from about 1 wt-% to about 10 wt-% of the composition, and the additional emulsion breaker comprises from about 90 wt-% to about 99 wt-% of the composition.

In addition to the demulsifiers, the methods can also include one or more antifoulants (or antifouling chemistry) for injecting into the production fluid. Exemplary antifoulants include for example, silicone-based or fluoropolymer coatings creating a slick surface that prevents organisms from adhering to it. Exemplary antifoulants including dispersants which prevents coagulation and flocculation of organics in water, including for example, Epichlorohydrin Dimethylamine and Methacrylamidopropyl Trimethylammonium Chloride.

In an embodiment, the methods disclosed herein reduce the need for an antifoulant. In an embodiment, the methods reduce the need for antifoulant injection after separation and before cooling. In an embodiment, the method does not comprise injecting the production fluid with an antifouling chemistry, before and/or after separation.

In an embodiment, the demulsifier is injected into the production fluid at a concentration of from about 5 ppm to about 100 ppm, or from about 5 ppm to about 70 ppm, or from about 10 ppm to about 30 ppm. In an embodiment, the demulsifier and additional emulsion breaker is injected into the production fluid at a concentration of from about 5 ppm to about 100 ppm, or from about 5 ppm to about 70 ppm, or from about 10 ppm to about 30 ppm.

In an embodiment, the injecting occurs when the production fluid is at a temperature of greater than about 100° C., from about 100° C. to about 200° C., or from about 110° C. to about 160° C.

In an embodiment, the produced water is cooled in a produced water cooler to a temperature of less than about 110° C., less than about 100° C., or to about 80° C. Without being limited to a particular mechanism or theory, the temperature reduction in the heat exchanger significantly lowers the solubility of residual organics in the water, leading to fouling in the heat exchanger. The demulsifier described herein maintains soluble organics in the crude oil phase during the separation process. Consequently, there is a decreased presence of soluble organics in the produced water phase, thereby mitigating fouling issues in the cooler. This also allows for a lower produced water temperature in the heat exchanger. Conventional methods typically do not reduce the temperature of the produced water below about 110° C. due to the soluble organics.

The produced water cooler described herein comprises a heat exchanger and is meant to include any heat exchanger or cooler as known in the art. Exemplary heat exchangers include a spiral heat exchanger, a shell and tube heat exchanger, a counter current heat exchanger, a co-current heat exchanger, and the like.

In an embodiment, the methods described herein result in an increase in production time for the water coolers. The water coolers can be in operation for more days before cleaning is required. The methods result in increased time between cleanings compared to an otherwise identical method absent the injection of the demulsifier described herein. In an embodiment, the time between produced water cooler cleaning is at least about 8 days, at least about 10 days, or at least about 15 days.

In an embodiment, the methods described herein result in increased total water throughput in the produced water cooler compared to an otherwise identical method absent the injection of the demulsifier described herein. In an embodiment, the total water throughput is increased by at least about 50%, at least about 75%, or at least about 90%.

In the methods described herein, after the water is cooled in the produced water cooler, the cooled water, or a portion thereof, can be used for steam generation in the SAGD system. In an embodiment, the cooled water, or a portion thereof, is sent for further processing.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Integration of Nonyl Resin into Demulsifier Product

In order to access the efficacy of the demulsifiers disclosed herein, separation tests were conducted. This test was conducted by injecting a demulsifier at a plant prior to the reverse emulsion entering the separation vessels. Nonyl Resin ranging from about 5 ppm to 10 ppm was injected with an additional demulsifier including polyamine and sorbitol ranging from about 200 ppm to 600 ppm.

The general operating conditions included the following which are customary for SAGD production:

Operational temperature range: about 110° C. to 160° C. The temperature was about 130° C. for separation, and cooling to below about 90° C. from inlet to outlet of cooler took place.

Pressure requirements: Exceeding the water vapor pressure at the specified operating temperature, typically within the range of about 50-200 PSI.

Flow characteristics: Laminar flow was maintained in the separation vessel, while turbulent flow was necessary in the heat exchanger and produced water cooler (PWC).

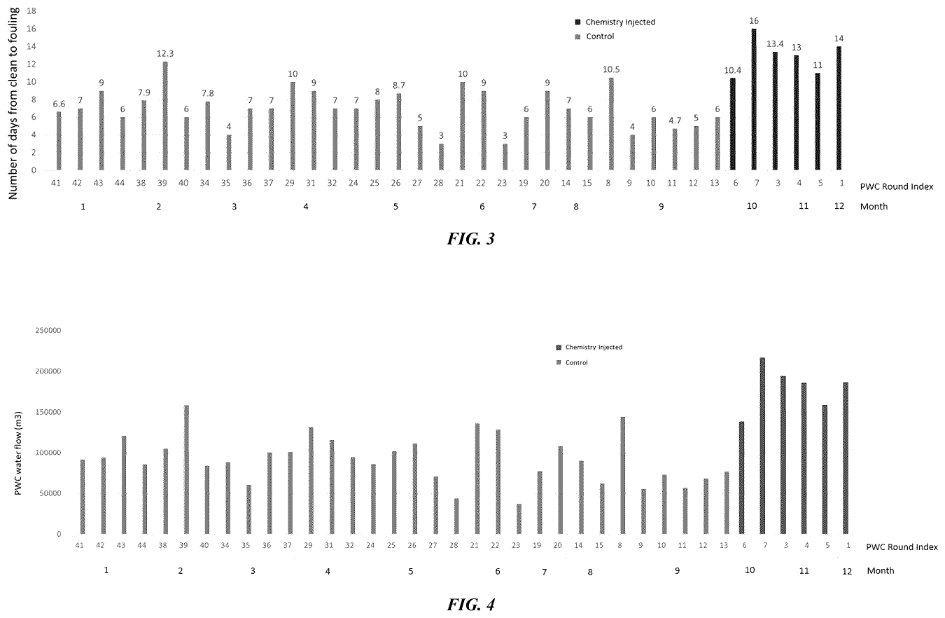

The test ran for a period of three months at these general operating conditions and other chemical programs maintained consistently for comparison purposes. A marked improvement in PWC was observed, as depicted in FIG. 3 which displays the quantity of days before fouling from soluble organics in the produced waters required taking the PWC offline for cleaning as impacted by the nonyl resin combined with the demulsifier chemistry. From a commercial perspective any increase in number of days for increased operations provide significant operating and cost benefits.

Within FIG. 3, the number of days before the requirement to take the PWC offline due to fouling for cleaning and removal of fouling was plotted on the vertical axis versus time on the horizontal axis. Time on the horizontal axis is labeled with both Month and PWC Round Index. PWC Round Index serves as a unique identifier for data recording and does not represent any physical or chemical properties. A ‘round’ is defined as the interval from the moment a clean cooler is activated (online) until it is deactivated for maintenance (offline). The three-month period during which the demulsifier compositions was applied is darkly colored, contrasting with the blank/control comparison, which is lightly colored. An 83.4% increase in PWC run time was observed when the demulsifier composition was applied.

Hypothesis testing further validated that the demulsifier compositions significantly extended the PWC's operating duration. The confidence interval at the 90% level with the demulsifier composition applied ranged from 10.8 to 15.1 days, while the same 90% confidence level interval without the coagulant and demulsifier compositions ranged from between 6.2 to 7.8 days.

Further testing was conducted to observe the impact of the demulsifier composition on the PWC water flow throughput. The results of the PWC water flow testing are shown in FIG. 4.

The total water throughput between taking the PWC offline for cleaning was plotted on the vertical axis versus time on the horizontal axis. Time on the horizontal axis is labeled with both Month and PWC Round Index. PWC Round Index serves as a unique identifier for data recording and does not represent any physical or chemical properties. A ‘round’ is defined as the interval from the moment a clean cooler is activated (online) until it is deactivated for maintenance (offline). The three-month period during which the chemical was applied is darkly colored, while the blank/control comparison is lightly colored. A 94.2% increase in PWC water flow was observed when the demulsifier composition was employed prior to phase separation.

Hypothesis testing confirmed that the demulsifier composition significantly extended the PWC's throughput between taking the PWC offline for cleaning. The confidence interval at the 90% level with the applied chemistry ranged from 150,813 m³ to 208,603 m³, while the same confidence interval without the chemical ranged from 81,885 m³ to 102,884 m³.

### Example 2

### Imidazoline Injected Before Phase Separation

Following the test described in Example 1, Imidazoline (conventional corrosion inhibitor) was injected with the demulsifiers EPON resin and sorbitol before phase separation of a reverse emulsion at a total concentration between about 30-70 ppm (where the demulsifiers made up between 5-20 wt % of the chemistry employed), while all other chemical programs and operational conditions remained consistent as described in Example 1 with the injection prior to the reverse emulsion entering the separation vessels.

The test maintained a ratio of anti-fouling chemistry to total demulsifier volume between about 0.05 and 0.1.

To assess PWC fouling, the opening of the cooling phase valve was closely monitored. When a reduction in heat exchange efficiency occurs due to fouling, this results in a requirement to increase the valve opening percentage of the cooling phase in order to lower the outlet temperature of the produced water phase. This is done to compensate for the diminished heat exchange efficiency.

The results of the cooling phase valve open percent testing showed that with the demulsifier composition made up of EPON resin, polyamine and imidazoline added prior to the separation phase, the cooling valve open percentage remained within about 30-70 percent open. Without the demulsifier composition added prior to the separation phase, the cooling phase valve opened between 0-100 percent, fully opening and fully closing multiple times during the cycle; which did not occur when the demulsifier compositions was added. These results show that the application of the demulsifier compositions resulted an increase in PWC operational time as compared to the trial without the demulsifier composition added.

The present disclosure is further defined by the following numbered embodiments.

1. A method for reducing fouling in a water cooler in a Steam Assisted Gravity Drainage system with a produced water cooler comprising: injecting a production fluid with a reverse emulsion with at least one demulsifier that is a resin, sorbitol, triol, crosslinked polyglycol, or combination thereof combined with an additional demulsifier for water-oil separation prior to phase separation of the production fluid; separating water from the reverse emulsion at a temperature above about 100° C. to form a produced water phase, wherein the produced water has a reduced amount of organic residue thereby reducing fouling of the produced water cooler; and cooling the produced water phase.

2. The method of embodiment 1, wherein the demulsifier is a resin selected from the group consisting of butyl resin, nonyl/butyl resin, amyl resin, nonyl resin, nonylphenyl resin, EPON resin, and sorbitol/EPON resin crosslinked.

3. The method of embodiment 1, wherein the demulsifier is a sorbitol, alkoxylated sorbitol, triol, crosslinked polyglycol, or combinations thereof.

4. The method of embodiment 1, wherein the demulsifier is EPON resin and the additional demulsifier is an alkoxylated sorbitol.

5. The method of embodiment 1, wherein the demulsifier is a resin selected from the group consisting of butyl resin, nonyl/butyl resin, amyl resin, nonyl resin, nonylphenyl resin, EPON resin, and sorbitol/EPON resin crosslinked, and/or is a sorbitol, alkoxylated sorbitol, triol, crosslinked polyglycol, or combination thereof, and is further combined with the additional demulsifier selected from the group consisting of a polyamine, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, and combination thereof.

6. The method of any one of embodiments 1-3, wherein the additional demulsifier comprises a polyamine, alkoxylated sorbitol, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, or combinations thereof.

7. The method of any one of embodiments 1-6, wherein injection of the production fluid further comprises an additional emulsion breaker.

8. The method of embodiment 7, wherein the additional emulsion breaker comprises an amine.

9. The method of embodiment 8, wherein the amine is diethylenetriamine and/or ethylenediamine.

10. The method of any one of embodiments 8-9, wherein the amine is diethylenetriamine and ethylenediamine.

11. The method of any one of embodiments 7-10, wherein the additional emulsion breaker and demulsifier are provided in a single composition.

12. The method of any one of embodiments 7-11, wherein the demulsifier comprises from about 0.1 wt-% to about 20 wt-% of the composition, and the additional emulsion breaker comprises from about 20 wt-% to about 99.9 wt-% of the composition.

13. The method of any one of embodiments 7-12, wherein the demulsifier comprises from about 1 wt-% to about 10 wt-% of the composition, and the additional emulsion breaker comprises from about 90 wt-% to about 99 wt-% of the composition.

14. The method of embodiment 7, wherein the additional emulsion breaker and demulsifier are injected separately into the production fluid.

15. The method of any one of embodiments 1-14, further comprising injecting the production fluid with an antifouling chemistry.

16. The method of any one of embodiments 1-14, wherein the method does not comprise injecting the production fluid with an antifouling chemistry.

17. The method of any one of embodiments 1-16, wherein the production fluid comprises bitumen and water.

18. The method of any one of embodiments 1-17, wherein the demulsifier and if present the additional emulsion breaker are injected at a concentration of from about 5 ppm to about 100 ppm, or from about 5 ppm to about 70 ppm, or from about 10 ppm to about 30 ppm.

19. The method of any one of embodiments 1-18, wherein the injecting is at a temperature between about 110-160° C.

20. The method of any one of embodiments 1-19, wherein the produced water phase is cooled to temperature of less than about 100° C. in the produced water cooler.

21. The method of embodiment 20, wherein the produced water phase is cooled to a temperature of about 80° C. in the produced water cooler.

22. The method of any one of embodiments 1-21, wherein the method results in increased time between produced water cooler cleaning compared to an otherwise identical method absent the injection of the demulsifier.

23. The method of embodiment 22, wherein the time between produced water cooler cleaning is at least about 8 days, at least about 10 days, or at least about 15 days.

24. The method of any one of embodiments 1-23, wherein the method results in increased total water throughput in the produced water cooler compared to an otherwise identical method absent the injection of the demulsifier.

25. The method of embodiment 24, wherein the total water throughput is increased by at least about 50%, by at least about 75%, or at least about 90%.

26. The method of any one of embodiments 1-25, wherein the injecting occurs upstream of a separation vessel.

27. The method of any one of embodiments 1-26, wherein the injecting occurs at an inlet to a separation vessel.

28. The method of any one of embodiments 1-27, wherein the produced water cooler comprises a heat exchanger.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

In view of the above, it will be seen that the several objects of the disclosure and the invention are achieved and other advantageous results attained.

As various changes could be made in the above methods without departing from the scope of the invention, it is intended that all matter contained in the above description and shown in the accompanying drawing shall be interpreted as illustrative and not in a limiting sense.

What is claimed is:

1. A method for reducing fouling in a water cooler in a Steam Assisted Gravity Drainage system with a produced water cooler comprising:
injecting a production fluid with a reverse emulsion with at least one demulsifier that is a resin, sorbitol, triol, crosslinked polyglycol, or combination thereof combined with an additional demulsifier for water-oil separation prior to phase separation of the production fluid;
separating water from the reverse emulsion at a temperature above about 100° C. to form a produced water phase, wherein the produced water has a reduced amount of organic residue thereby reducing fouling of the produced water cooler; and
cooling the produced water phase.

2. The method of claim 1, wherein the demulsifier is a resin selected from the group consisting of butyl resin, nonyl/butyl resin, amyl resin, nonyl resin, nonylphenyl resin, EPON resin, and sorbitol/EPON resin crosslinked.

3. The method of claim 1, wherein the demulsifier is a sorbitol, alkoxylated sorbitol, triol, crosslinked polyglycol, or combinations thereof.

4. The method of claim 1, wherein the emulsifier is EPON resin and the additional demulsifier is an alkoxylated sorbitol.

5. The method of claim 1, wherein the demulsifier is a resin selected from the group consisting of butyl resin, nonyl/butyl resin, amyl resin, nonyl resin, nonylphenyl resin, EPON resin, and sorbitol/EPON resin crosslinked, and/or is a sorbitol, alkoxylated sorbitol, triol, crosslinked polyglycol, or combination thereof, and is further combined with the additional demulsifier selected from the group consisting of a polyamine, dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, and combination thereof.

6. The method of claim 1, wherein the additional demulsifier comprises a polyamine, alkoxylated sorbitol. dodecylbenzenesulfonic Acid (DDBSA), trimethylolpropane (TMP), 2-Mercaptoethanol, alkyl pyridine, alkyl pyridine quaternary ammonium compound, hydroquinone, imidazoline, or combinations thereof.

7. The method of claim 1, wherein injection of the production fluid further comprises an additional emulsion breaker.

8. The method of claim 7, wherein the additional emulsion breaker is diethylenetriamine and/or ethylenediamine.

9. The method of claim 7, wherein the demulsifier is EPON resin, the additional demulsifier is alkoxylated sorbitol, and the additional emulsion breaker is diethylenetriamine and ethylenediamine.

10. The method of claim 7, wherein the additional emulsion breaker and demulsifier are provided in a single composition, wherein the demulsifier comprises from about 0.1 wt-% to about 20 wt-% of the composition, and the additional emulsion breaker comprises from about 20 wt-% to about 99.9 wt-% of the composition.

11. The method of claim 7, wherein the additional emulsion breaker and demulsifier are injected separately into the production fluid.

12. The method of claim 1, further comprising injecting the production fluid with an antifouling chemistry.

13. The method of claim 1, wherein the method does not comprise injecting the production fluid with an antifouling chemistry.

14. The method of claim 1, wherein the demulsifier and if present the additional emulsion breaker are injected at a concentration of from about 5 ppm to about 100 ppm, or from about 5 ppm to about 70 ppm, or from about 10 ppm to about 30 ppm.

15. The method of claim 1, wherein the injecting is at a temperature between about 110-160° C.

16. The method of claim 1, wherein the produced water phase is cooled to a temperature of less than about 100° C., or to about 80° C., in the produced water cooler.

17. The method of claim 1, wherein the method results in increased time between produced water cooler cleaning compared to an otherwise identical method absent the injection of the demulsifier.

18. The method of claim 1, wherein the method results in increased total water throughput in the produced water cooler compared to an otherwise identical method absent the injection of the demulsifier.

19. The method of claim 1, wherein the injecting occurs upstream of a separation vessel, or at an inlet to a separation vessel.

20. The method of claim 1, wherein the produced water cooler comprises a heat exchanger.
